(19) United States
(12) Patent Application Publication
(10) Pub. No.: US 2006/0164693 A1
(43) Pub. Date: Jul. 27, 2006

(54) Generating a protected document image having a visible verification image

(76) Inventors: Tsutomu Matsumoto, Kanagawa (JP); Takashi Saitoh, Tokyo (JP); Yasushi Abe, Kanagawa (JP); Masaki Ishii, Kanagawa (JP); Takayuki Hara, Kanagawa (JP)

Correspondence Address: OBLON, SPIVAK, MCCLELLAND, MAIER & NEUSTADT, P.C., 1940 DUKE STREET, ALEXANDRIA, VA, 22314, US

(21) Appl. No.: 11/288,172

(22) Filed: Nov. 29, 2005

(30) Foreign Application Priority Data
Nov. 29, 2004 (JP) 2004-344872

(51) Int. Cl. H04N 1/40

(52) U.S. Cl. 358/3.28

(57) ABSTRACT

An apparatus, method, system, computer program and product for generating a protected document image having a visible verification image. Using the visible verification image, the integrity of the protected document image can be visually checked without requiring machine intervention.

### RELATED APPLICATION

This patent application is based on and claims priority to Japanese patent application No. JPAP2004-344872 filed on Nov. 29, 2004, in the Japanese Patent Office, the entire contents of which are incorporated herein by reference.

### BACKGROUND OF THE INVENTION

1. Field of the Invention

The following disclosure relates generally to an apparatus, method, computer program and product for generating a protected document image having a visible verification image.

2. Description of the Related Art

Various methods have been empolyed to protect a document image from undesired alteration, such as tampering. For example, a verification image, which is extracted from the document image, may be embedded into the document image to generate a protected document image. By checking the verification image of the protected document image, a user can check the integrity of the print document image.

However, the above-described and other existing methods for detecting undesired alteration of a document image often require machine intervention. As a result, the integrity of the protected document image can be checked only when an appropriate detecting apparatus is available, which makes the existing methods less practical for use in some applications.

### SUMMARY OF THE INVENTION

An exemplary embodiment of the present invention includes an apparatus, method, system, computer program and product, for generating a protected document image having a visible verification image. Using the visible verification image, the integrity of the protected document image can be visually checked without requiring machine intervention.

For example, the protected document image may be generated by performing an operation including the steps of: obtaining a document image to be processed; designating information in the document image to be protected; converting the designated information to protected information using a conversion rule; generating a visible verification image, including the protected information being expressed in a visible form and arranged in a position determined by an arrangement rule; and adding the visible verification image to the document image.

In order to detect whether the protected document image has been altered, characteristics of the visible verification image, determined by any one of the conversion rule, the visible form, or the arrangement rule, may be visually checked by the user. If any one of the characteristics of the visible verification image has been altered, the user may determine that the protected document image has been altered.

### BRIEF DESCRIPTION OF THE DRAWINGS

A more complete appreciation of the disclosure and many of the attendant advantages thereof will be readily obtained as the same becomes better understood by reference to the following detailed description when considered in connection with the accompanying drawings, wherein:

FIG. 1 is a flowchart illustrating the operation of generating a protected document image according to an exemplary embodiment of the present invention;

FIG. 2 is a schematic block diagram illustrating the structure of a protected document generating apparatus according to an exemplary embodiment of the present invention;

FIG. 3 is a flowchart illustrating the operation of generating a protected document image, performed by the protected document generating apparatus of FIG. 2, according to an exemplary embodiment of the present invention;

FIG. 4 is an exemplary screen displayed by the protected document generating apparatus of FIG. 2;

FIG. 5 is an exemplary screen displayed by the protected document generating apparatus of FIG. 2;

FIG. 6 is an exemplary screen displayed by the protected document generating apparatus of FIG. 2;

FIG. 7 is an exemplary visible verification image generated by the protected document generating apparatus of FIG. 2;

FIG. 8 is an exemplary protected document image generated by the protected document generating apparatus of FIG. 2;

FIG. 9 is an exemplary protected document image generated by the protected document generating apparatus of FIG. 2;

FIG. 10 is a flowchart illustrating the operation of generating a protected document image, performed by the protected document generating apparatus of FIG. 2, according to an exemplary embodiment of the present invention;

FIG. 11 is an exemplary screen displayed by the protected document generating apparatus of FIG. 2;

FIG. 12 is an exemplary screen displayed by the protected document generating apparatus of FIG. 2;

FIG. 13 is an exemplary screen displayed by the protected document generating apparatus of FIG. 2;

FIG. 14 is an exemplary protected document image generated by the protected document generating apparatus of FIG. 2;

FIG. 15 is an exemplary protected document image generated by the protected document generating apparatus of FIG. 2;

FIG. 16 is a flowchart illustrating the operation of generating a protected document image, performed by the protected document generating apparatus of FIG. 2, according to an exemplary embodiment of the present invention;

FIG. 17 is a user preference table used by the protected document generating apparatus of FIG. 2, according to an exemplary embodiment of the present invention;

FIG. 18 is a position table used by the protected document generating apparatus of FIG. 2, according to an exemplary embodiment of the present invention;

FIG. 19 is an exemplary screen displayed by the protected document generating apparatus of FIG. 2;

FIG. 20 is a pattern table provided to a user for visually detecting alteration of a protected document image, according to an exemplary embodiment of the present invention;

FIG. 21 is an exemplary protected document image generated by the protected document generating apparatus of FIG. 2; and

FIG. 22 is a schematic block diagram illustrating the structure of a protected document generating system according to an exemplary embodiment of the present invention.

### DETAILED DESCRIPTION OF THE EXEMPLARY EMBODIMENTS

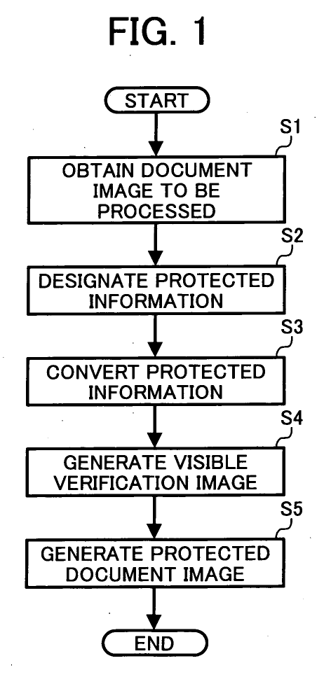

In describing the exemplary embodiments illustrated in the drawings, specific terminology is employed for clarity. However, the disclosure of this patent specification is not intended to be limited to the specific terminology selected and it is to be understood that each specific element includes all technical equivalents that operate in a similar manner. Referring now to the drawings, wherein like reference numerals designate identical or corresponding parts throughout the several views, FIG. 1 illustrates the operation of generating a protected document image according to an exemplary embodiment of the present invention.

Step S1 includes obtaining a document image to be processed. The document image may be provided in various forms, for example, as electronic data, as a printed document, or any other medium. Further, the document image may include any kind of information including characters, numerals, signs, marks, lines, pictures, drawings, etc.

Step S2 includes designating information in the document image to be protected. In this example, the protected information includes any kind of information extracted by a user from the document image.

Step S3 includes converting the information to protected information using a conversion rule. The conversion rule defines how the designated information is converted to the protected information. For example, the conversion rule may define an encryption method for converting the designated information into the protected information using variable secret information. Further, the conversion rule may define an encryption method for converting the designated information into the converted protected information using variable secret information and invariable secret information. Furthermore, the conversion rule may define that the designated information is used as the converted protected information. The conversion rule may be previously set or it may be set according to the user's preferences.

Step S4 includes generating a visible verification image having the converted protected information. The converted protected information is expressed in a visible form, for example, as a symbol. The symbol may be expressed in various symbol types including numerals, characters, marks, patterns, etc. Further, the symbol may be expressed in various ways by changing one of its attribute, such as its color, font, size, etc. The visible form may be previously set or it may be set according to the user's preferences, as long as it can be distinguished from information originally contained in the document image.

Further, the converted protected information is arranged in a position determined by an arrangement rule. The arrangement rule helps the user to specify the position of the converted protected information in the visible verification image. For example, the arrangement rule defines an arrangement pattern indicating how the converted protected information is arranged in the visible verification image. In another example, the arrangement rule defines a valid cell indicating a specific position of the converted protected information in the document image. The arrangement rule may be previously set or it may be set according to the user's preferences.

Step S5 includes generating a protected document image by adding the visible verification image to the document image. For example, the visible verification image may be superimposed on the document image as a background image. In another example, the visible verification image may be added to a non-data section of the document image, such as a margin or a blank space of the document image. The protected document image may be provided in various ways, for example, as electronic data, as a printed document, or any other medium, as long as the user can visually check the integrity of the protected document image by using the visible verification image.

The steps illustrated in FIG. 1 may be performed in a different order than described above or illustrated in FIG. 1. Further, the operation illustrated in FIG. 1 may be performed in various ways.

In one example, the operation of FIG. 1 may further include the step of authenticating or authorizing the user, preferably before performing the Step S1.

In another example, the Step S4 may generate a visible verification image having the converted protected information and dummy information. The dummy information is provided so as to prevent unauthenticated or unauthorized users from specifying the position of the converted protected information in the visual verification image. For example, the converted protected information and the dummy information may be expressed in the same visible form and arranged according to the same arrangement pattern. However, the dummy information would provide information different from information given by the converted protected information. Since the information given by the converted protected information is known only to the authenticated or authorized user, the converted protected information and the dummy information can be distinguished from each other only by the authenticated or authorized user.

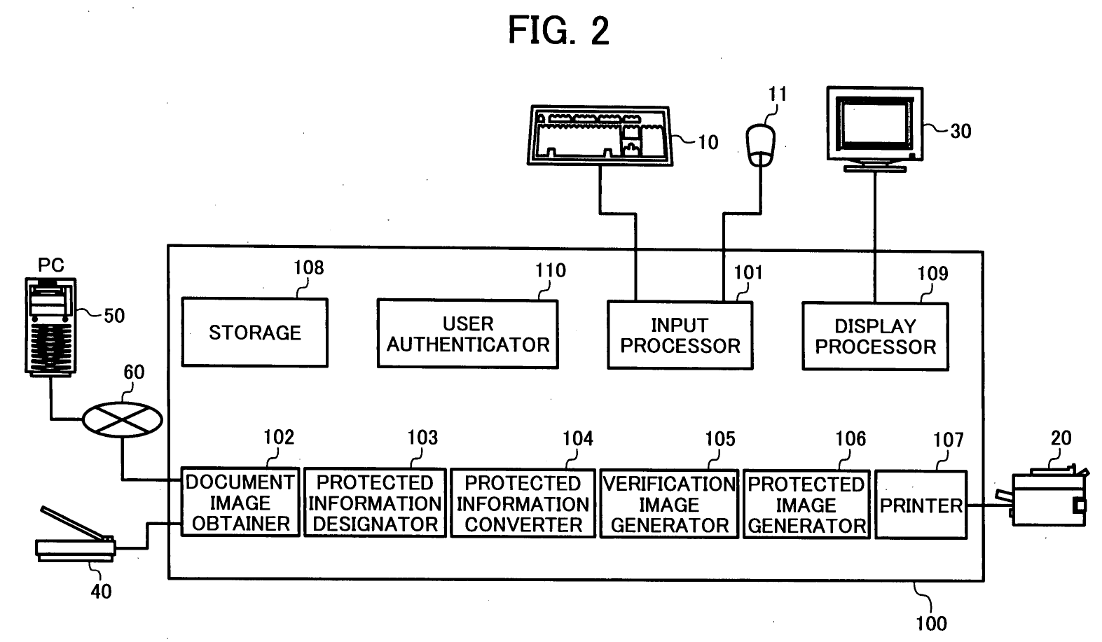

Further, the operation illustrated in FIG. 1 may be performed by any kind of image processing apparatus including a protected document generating apparatus 100 shown in FIG. 2.

As shown in FIG. 2, the protected document generating apparatus 100 includes an input processor 101, a document image obtainer 102, a protected information designator 103, a protected information converter 104, a verification image generator 105, a protected image generator 106, a printer 107, a storage 108, a display processor 109, and a user authenticator 110.

The storage 108 stores various data including an authentication table, a document image to be processed by the apparatus 100, or a protected document image generated by the apparatus 100, for example.

The input processor 101 is connected to an input device, such as a keyboard 10 and a pointing device 11. The input processor 101 receives information input by the user via the input device. Examples of such information include input of authentication information, selection of a document image to be processed by the apparatus 100, designation of protected information, selection of a conversion rule such as input of variable secret information, selection of a visible form expressing the converted protected information, selection of an arrangement rule, etc.

The user authenticator 110 authenticates a user by comparing the authentication information input by the user with information provided by the authentication table stored in the storage 108.

The document image obtainer 102 obtains a document image to be processed from various sources. As shown in FIG. 2, the document image obtainer 102 may be connected to a scanner 40, and to a personal computer (PC) 50 via a network 60. In one example, the scanner 40 scans a printed document into electronic document data, and sends it to the document image obtainer 102 as a document image. In another example, the PC 50 may generate data, such as document data or image data, using any kind of software programs, and sends it to the document image obtainer 102 via the network 60 as a document image. In another example, the document image obtainer 102 may obtain data stored in the storage 108 as a document image. In this example, the network 60 may include any kind of network, including a local area network (LAN) or the Internet, for example.

The protected information designator 103 designates protected information in the document image according to an instruction input by the user through the input device.

The display processor 109 is connected to a display 30. The display 30 includes any kind of display device such as a liquid crystal display, for example. The display processor 109 displays various data on the display 30, including the document image, the visible verification image, or the protected document image. Further, the display processor 109 displays various messages or menus on the display 30, which requests the user to input information.

The protected information converter 104 converts the designated information to protected information using a conversion rule.

The verification image generator 105 generates a visible verification image having the converted protected information. The converted protected information is expressed in a visible form, and is arranged in the position determined by an arrangement rule. In addition to the converted protected information, the visible verification image may include dummy information having information different from information of the converted protected information.

The protected image generator 106 generates a protected document image by adding the visible verification image to the document image.

The printer 107 is connected to a printer 20. The printer 107 may print the protected document image as a printed protected document image, according to a user's instruction.

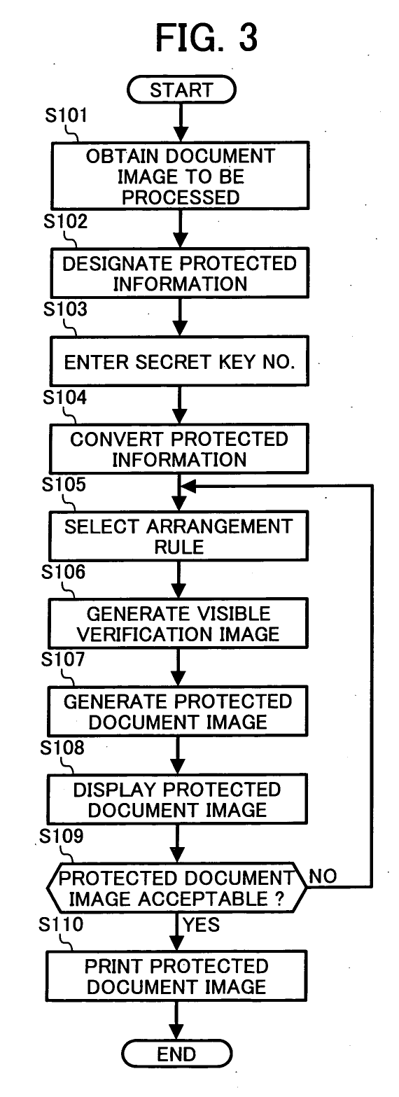

Referring now to FIG. 3, the operation of generating a protected document image is explained according to an exemplary embodiment of the present invention. The steps illustrated in FIG. 3 may be performed by the protected document generating apparatus 100 when the input processor 101 receives an instruction for generating a protected document image from a user.

Step S101 includes obtaining a document image to be processed. In one example, the display processor 109 may display a message on the display 30 which requests the user to select a document image to be processed. Through the input device, the user may instruct the apparatus 100 to obtain the document image from the scanner 40, for example. The input processor 101 receives the instruction to obtain the document and causes the document image obtainer 102 to obtain the document image through the scanner 40. In this example, an invoice having the total due amount of 300.00 dollars is obtained for further processing.

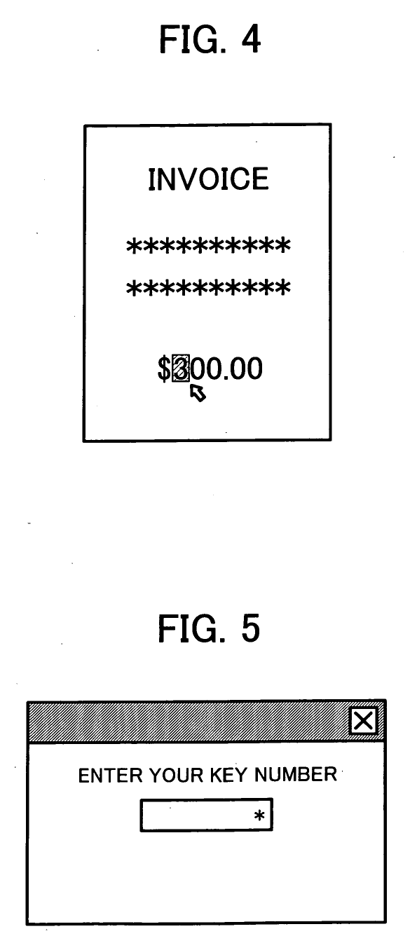

Step S102 includes designating information to be protected in the document image. In this example, the display processor 109 displays the invoice obtained in Step S101 on the display 30. The display processor 109 additionally displays a message requesting the user to select a portion of the invoice as the protected information. In this example, as shown in FIG. 4, the user selects the Arabic numeral “3” by moving the cursor displayed on the display 30 with the pointing device 11. Once the number “3” is selected, the cell corresponding to the number “3” turns to gray as shown in FIG. 4. At the same time, the input processor 101 causes the protected information designator 103 to designate the number “3” as the protected information.

Step S103 includes allowing the user to enter variable secret information which is used for converting the designated information. In this example, the display processor 109 displays a message shown in FIG. 5, which requests the user to enter a secret key number as the variable secret information. Using an input device such as the keyboard 10, the user may input any number as the secret key number, for example, the number “5”. The input processor 101 sends the secret key number “5” to the protected information converter 104.

Step S104 includes converting the designated information to protected information using a conversion rule. In this example, the conversion rule is defined such that the variable secret information is added to the protected information to obtain combined information, and the combined information is divided by invariable secret information to obtain remainder information, which is used as the converted protected information. In this example, the invariable secret information is previously set to a predetermined number “10”, which is relatively easy to remember.

More specifically, in this example, the protected information converter 104 adds the secret key number “5” to the protected information “3” to obtain the combined information “8”. The protected information converter 104 divides the combined information “8” by the number “10” to obtain the remainder information “8”. The remainder information “8” is then used as the converted protected information.

In this example, the invariable secret information may be previously set or it may be set according to the user's preferences, as long as it remains unchanged for a specific conversion rule. More specifically, the variable secret information, i.e., the secret key number, may vary for each page of the document image to be processed. However, the invariable secret information remains unchanged while processing the same document image.

Further, dummy information having information different from information given by the converted protected information may be generated. In this example, the dummy information includes any number that is obtainable as the remainder information but is different from the converted protected information “8”, such as 0, 1, 2, 3, 4, 5, 6, 7, and 9.

Step S105 includes selecting an arrangement rule. As described above with reference to FIG. 1, the arrangement rule helps the user to specify the position of the converted protected information in the visible verification image, by defining an arrangement pattern or a valid cell, for example.

In this example, the display processor 109 displays the Arrangement window shown in FIG. 6 on the display 30, which requests the user to select one of the arrangement patterns, including “Triangle Grid Pattern”, “Square Grid Pattern”, “Concentric Pattern”, and “Random Pattern”. By clicking one of the patterns with the pointing device 11, the user can view the arrangement of the converted protected information (the number “8”) and the dummy information (the numbers except “8”) in the “Preview” window. In this example, as shown in FIG. 6, the Arabic numeral is used as the visible form expressing the converted protected information and the dummy information by default. Further, the position of the converted protected information, i.e., the valid cell of the number “8” is previously set. Furthermore, the total number of numerals to be displayed as the dummy-information is determined according to the arrangement pattern. For example, if the “Random Pattern” is selected as shown in FIG. 6, eight numerals are randomly selected from the numerals 0, 1, 2, 3, 4, 5, 6, 7, and 9.

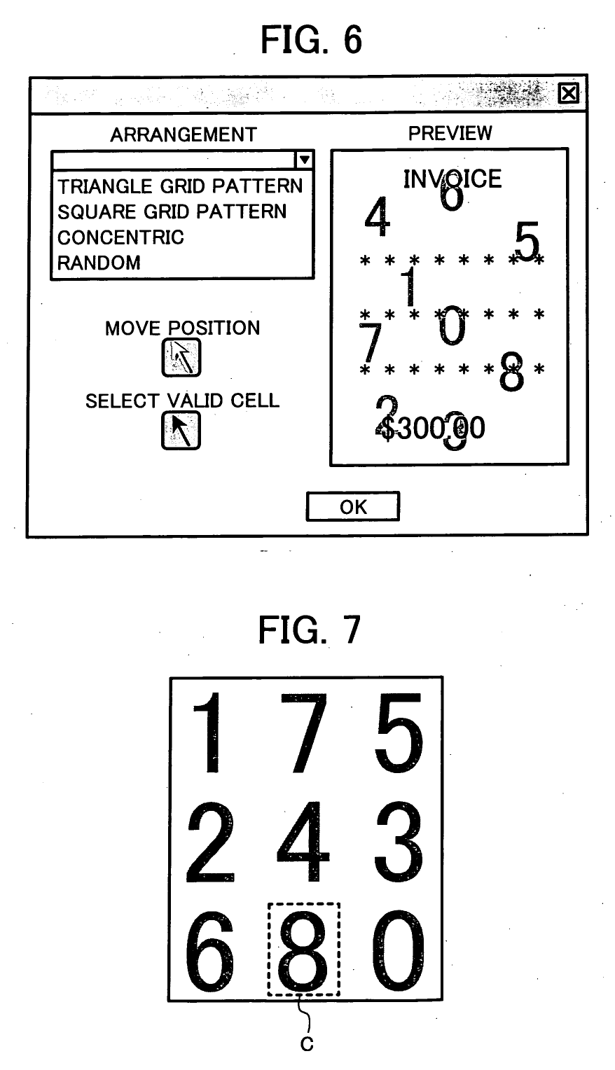

Further, in this example, the user may move the position of the dummy information in the “Preview” window. When the user selects the “Move position” button, the cursor is displayed on the “Preview” window. By moving the cursor with the input device, the user may change the position of the dummy information as long as it is arranged according to the selected arrangement pattern. For example, if the “Random pattern” is selected as illustrated in FIG. 6, the position of the dummy information can be freely changed. In another example, if the “Square Grid Pattern” is selected as illustrated in FIG. 7, the position of the dummy information can be changed as long as it forms the square grid pattern.

Furthermore, in this example, the user may change the position of the converted protected information in the “Preview” window. When the user selects the “Select Valid Cell” button, the cursor is displayed on the “Preview” window. By moving the cursor with the input device, the user may select the valid cell C indicating the position of the converted protected information, for example, as illustrated in FIG. 7.

Step S106 includes generating a visible verification image. The visible verification image has the converted protected information and the dummy information, each being arranged in the position determined by the arrangement rule set in Step S105. For example, if the user selects the “Square Grid Pattern”, the verification image generator 105 generates a visible verification image having the converted protected information “8” and the dummy information, which together forms the “Square Grid Pattern” as illustrated FIG. 7. Further, if the user selects the valid cell C to be in the middle of the lowest row in the square grid pattern, the verification image generator 105 generates a visible verification image having the converted protected information “8” arranged in the valid cell C as illustrated in FIG. 7. As mentioned above, in this example, the Arabic numeral is used as the visible form expressing the converted protected information and the dummy information.

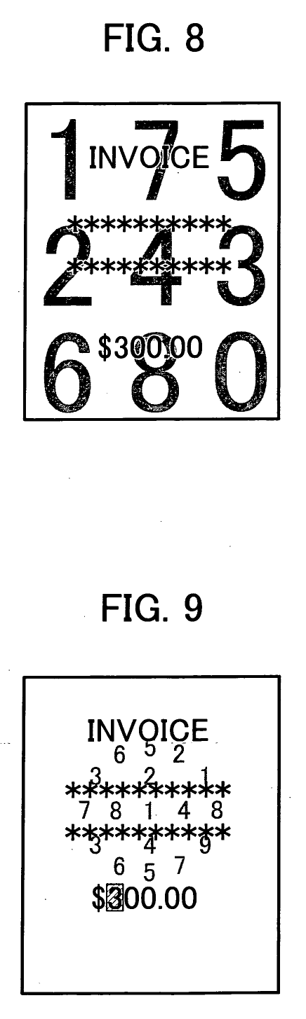

Step S107 includes generating a protected document image by adding the visible verification image to the document image. For example, the protected image generator 106 may superimpose the visible verification image of FIG. 7 on to the document image of FIG. 4 as a background image. As a result, the protected document image shown in FIG. 8 is generated.

Step S108 includes displaying the protected document image on the display 30. For example, the display processor 109 may display the protected document image generated in the Step S107 in the Preview window of the menu shown in FIG. 6.

Step S109 includes determining whether the displayed protected document image is acceptable. For example, the input processor 101 may determine whether the “OK” button displayed in the menu of FIG. 6 has been pressed by the user. If the “OK” button has been pressed (“YES” in Step S109), the operation proceeds to Step S110. If the “OK” button has not been pressed (“NO” in Step S109), the operation returns to the Step S105 to select another arrangement rule.

Step S110 includes printing the protected document image. After that step, the operation ends. For example, once the input processor 101 determines that the displayed protected document image is acceptable in the previous step, the input processor 101 may cause the printer 107 to print the protected document image. Before printing, the input processor 101 may store the displayed protected document image in the storage 108.

The operation illustrated in FIG. 3 may be performed in various ways.

In one example, the operation of FIG. 3 may further include the step of authenticating the user, preferably before performing the Step S101. Upon receiving the instruction for generating, the display processor 109 may display a message on the display 30, which requests the user to input authentication information, such as a user ID and a corresponding password. Once the authentication information is input via the input device, the input processor 101 causes the user authenticator 110 to authenticate the user by comparing the authentication information with information stored in the authentication table of the storage 108. The authentication table stores the user ID and the password in a corresponding manner for each of the registered users of the apparatus 100. By comparing whether the authentication information input by the user matches the corresponding authentication information stored in the authentication table, the user authenticator 10 can determine whether the user, who wishes to start the generating process, is allowed to generate a protected document image. When the user has been authenticated, the Steps S101 to S110 are performed by the apparatus 100. When the user is not authenticated, Steps S101 to S110 are not performed.

In another example, in the Step S106, the verification image generator 105 may adjust the position of the converted protected information or the dummy information according to the layout of the document image, as long as the position of the converted protected information can be specified. For example, the verification image generator 105 may extract a non-data section having no characters from the invoice shown in FIG. 4. If the non-data section has sufficient space to display the converted protected information or the dummy information, the verification image generator 105 may adjust the position of the converted protected information or the dummy information to be in the non-data section of the document image. As a result, the converted protected information or the dummy information may be prevented from overlapping the characters originally contained in the document image. This increases the visibility of the converted protected information or the dummy information in the protected document image.

In another example, in the Step S107, the protected image generator 106 may generate a protected document image having the protected information visibly distinguishable from other information, as illustrated in FIG. 9, for example. The protected information shown in FIG. 9 is shaded, however, the protected information may be displayed in various other ways, such as in a different color, so long as it can be distinguished from other information.

In another example, in the Step S106, the verification image generator 105 may arrange the converted protected information in more than one position of a visible verification image. For example, the visible verification image of FIG. 9 has two numerals “8”, each representing the converted protected information “8”.

If the converted protected information is to be displayed in more than one position in the visible verification image, the corresponding number of valid cells may be selected in the Step S105.

Further, if the converted-protected information is to be displayed in more than one position in the visible verification image, the protected information converter 104 may generate the corresponding number of converted protected information, each generation using a different conversion rule. For example, if converted protected information of the protected information “5” is to be displayed in three positions in the visible verification image, the protected information converter 104 may generate first converted protected information, second converted protected information, and third converted protected information. The first converted protected information may be made equal to the protected information. The second converted protected information may be obtained by applying a conversion rule of adding variable secret information to the protected information. The third converted protected information may be obtained by applying a conversion rule of subtracting variable secret information from the protected information.

To detect whether the protected document image has been altered, the user may perform the following four steps, for example.

First, the user specifies the protected information in the protected document image. For example, if the protected document image of FIG. 8 is provided, the user is assumed to remember that the number “3” has been assigned as the protected information. In another example, if the protected document image of FIG. 9 is provided, the user can visually see the number “3” as the protected information.

Second, the user obtains calculated converted protected information. The calculated converted protected information can be obtained by converting the protected information using a conversion rule. In this example, the user is assumed to remember the secret key number “5”, which is known only to the user. A conversion rule other than the secret key number “5” may be known to the public. Using the conversion rule known to the user, the user can obtain the number “8” as the calculated converted protected information.

Third, the user obtains displayed converted protected information. The displayed converted protected information can be obtained by specifying the position of the displayed converted protected information in the protected document image. For example, if the protected document image of FIG. 8 is provided, the user is assumed to remember that the valid cell is positioned in the middle of the lowest row of the square grid pattern. Once the valid cell is determined, the user can obtain the number “8” as the displayed converted protected information.

Fourth, the user determines whether the displayed converted protected information matches the calculated converted protected information. For example, if the protected document image of FIG. 8 is provided, the user determines whether the number “8” displayed in the valid cell matches the number “8”, i.e., the calculated converted protected information. Since they are identical, the user can determine that the protected document image of FIG. 8 has not been altered.

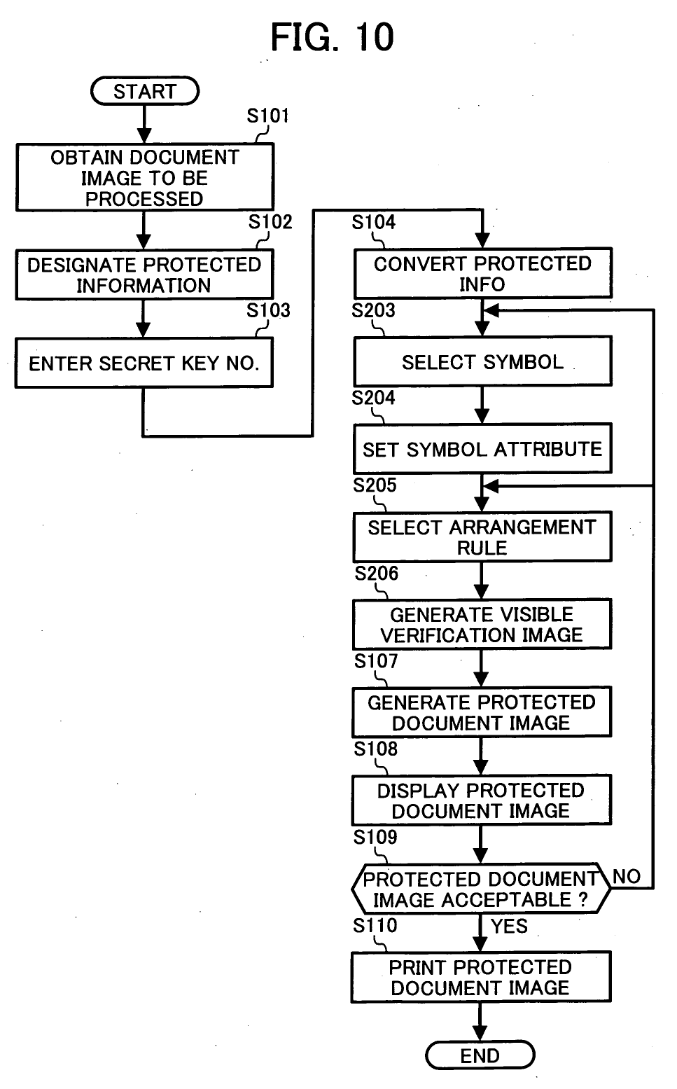

Referring now to FIG. 10, an operation of generating a protected document image, performed by the protected document generating apparatus 100, is explained according to an exemplary embodiment of the present invention.

The operation illustrated in FIG. 10 is substantially similar to the operation illustrated in FIG. 3. The differences include the addition of Step S203 and Step S204, replacement of Step S105 with Step S205, and replacement of Step S106 with Step S206. More specifically, in this example, the apparatus 100 allows the user to select a visible form expressing the converted protected information or the dummy information.

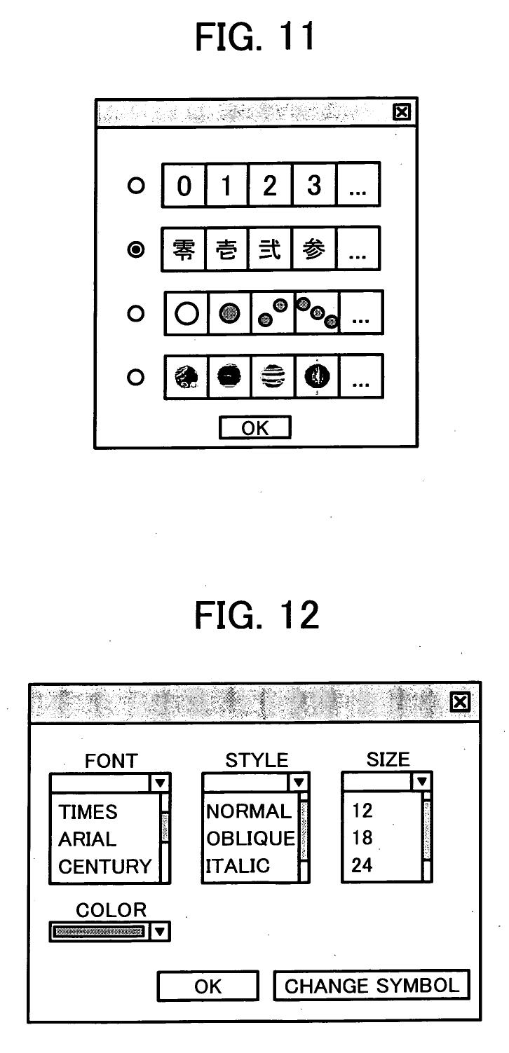

Step S203 includes selecting a visible form which is used to represent the converted protected information obtained in Step S104. In this example, the display processor 109 displays the menu shown in FIG. 11 on the display 30, which requests the user to select one of a plurality of symbol types. The user may select one of the symbol types, using the input device, such as the pointing device 11. The user may further confirm the selection by pressing the “OK” button shown in FIG. 11.

Step S204 includes setting a symbol attribute of the symbol type selected in Step S203. For example, if the user selects the numeral type “0, 1, 2, 3 . . . ” or the character type having a series of Chinese characters, the display processor 109 may display a menu shown in FIG. 12 which requests the user to set the symbol attribute of the selected symbol type, such as the font, style, size, or color of the symbol. Alternatively, when the user selects the mark type having a series of marks from the menu shown in FIG. 11, the display processor 109 may display another menu requesting the user to set the symbol attribute, such as the color or size of the mark. Alternatively, when the mark type is selected, the operation may proceed to Step S205 without performing Step S204. Once the selection is made using the input device, the user may confirm the selection by pressing the “OK” button shown in FIG. 12. Alternatively, the user may change the selected symbol type by pressing the “Change Symbol” button shown in FIG. 12.

Step S205 includes selecting an arrangement rule in a substantially similar manner as described with reference to the Step S105 of FIG. 3. However, in this example, the visible form, such as the symbol type or attribute, selected in the previous step, is used to express the converted protected information and the dummy information.

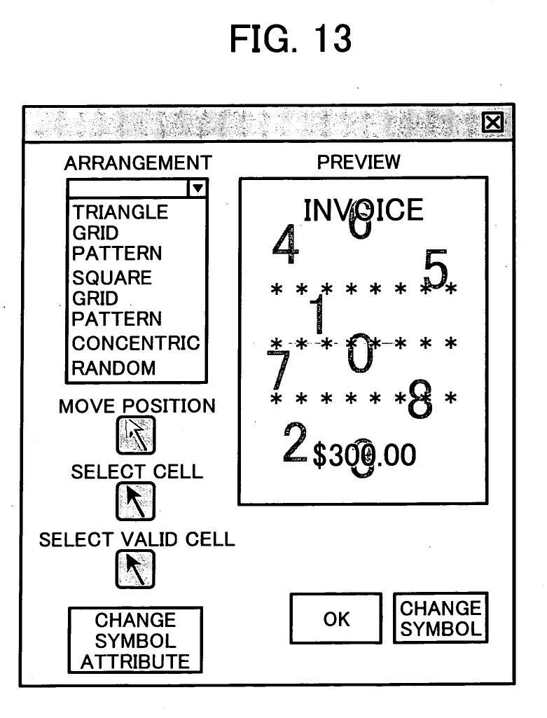

In this example, the display processor 109 displays a menu shown in FIG. 13, having the “Change Symbol” button, the “Change Symbol Attribute” button, and the “Select Cell” button, in addition to the windows or buttons provided by the menu shown in FIG. 6.

When the user presses the “Change Symbol” button of the menu shown in FIG. 13, the menu of FIG. 11 may be displayed on the display 30. Further, when the user presses the “Change Symbol Attribute” button of the menu shown in FIG. 13, the menu of FIG. 12 may be displayed on the display 30. In this manner, the user can set the symbol type or the symbol attribute. The converted protected information and the dummy information are then expressed in the visible form determined by the symbol type or the symbol attribute.

Further, in this example, the symbol type or the symbol attribute may be set independently for each of the symbols displayed in the “Preview” window. For example, if the user selects the “Select Cell” button of the menu shown in FIG. 13, the cursor is displayed on the “Preview” window. By moving the cursor with the input device, such as the pointing device 11, the user may select one of the symbols, i.e., the numerals. The user may set the symbol attribute or the symbol type for the selected symbol.

Step S206 includes generating a visible verification image having the converted protected information and the dummy information. The converted protected information and the dummy information are each arranged in the position determined by the arrangement rule set in the Step S205, in a substantially similar manner as described with reference to Step S106 of FIG. 3. However, in this example, the visible form expressing the converted protected information and the dummy information is determined by the symbol type selected in the Step S203 or the symbol attribute selected in the Step S204.

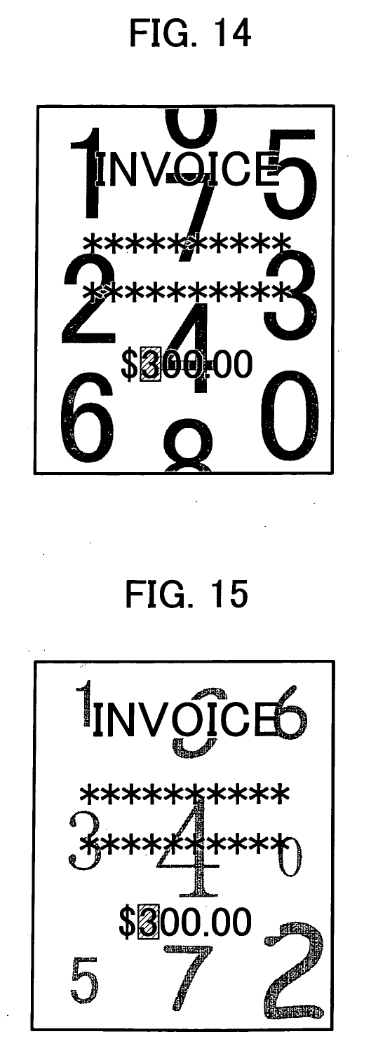

For example, if the user selects the numeral type as the symbol type, and the “Triangle Grid Pattern” as the arrangement pattern, the verification image generator 105 generates a visible verification image as shown in FIG. 14.

Further, the user may change the position or the symbol attribute of each numeral shown in FIG. 14 to generate a visible verification image as shown in FIG. 15.

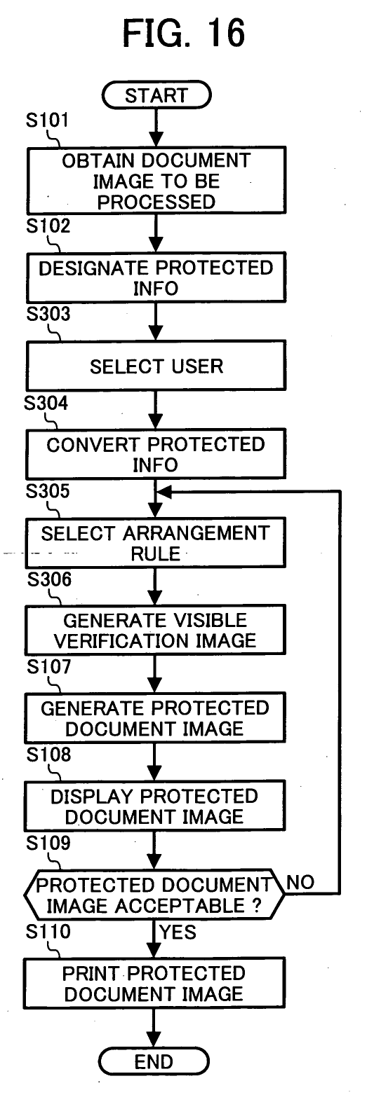

Referring now to FIG. 16, an operation of generating a protected document image, performed by the protected document generating apparatus 100, is explained according to an exemplary embodiment of the present invention.

The operation illustrated in FIG. 16 is substantially similar to the operation illustrated in FIG. 3. The differences include the addition of Step S303, replacement of Step S104 with Step S304, replacement of Step S105 with Step S305, and replacement of Step S106 with Step S306. More specifically, in this example, the apparatus 100 allows the user to have previously set at least one of the conversion rule, the visible form, and the arrangement rule, as preference data to be stored in the storage 108. The preference data may be used for defining at least one of the conversion rule, the visible form, and the arrangement rule, when generating the protected document image.

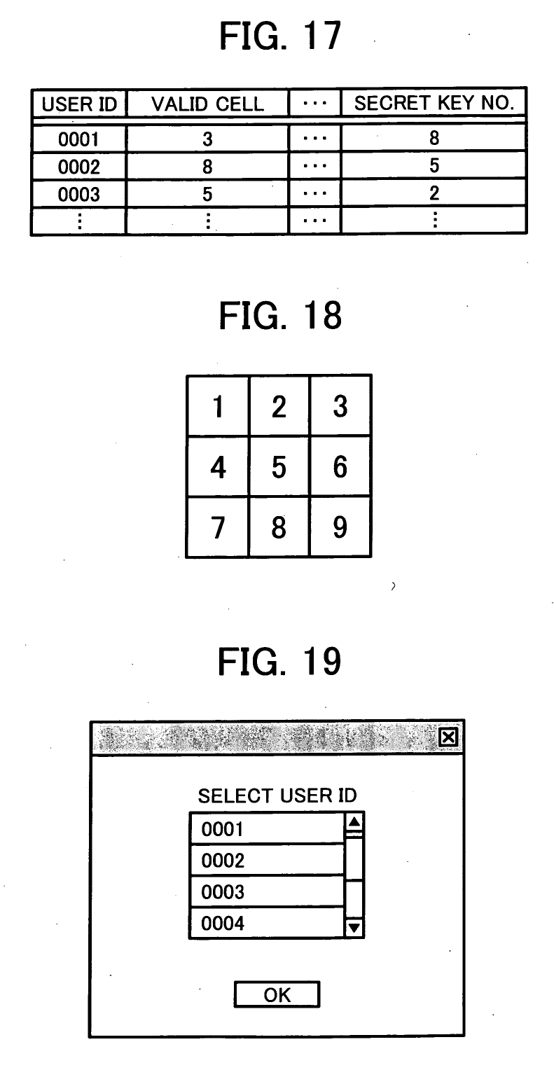

For example, the preference data may be stored in the storage 108 as a user preference table as shown in FIG. 17. The user preference table of FIG. 17 stores a plurality of user IDS, a plurality of valid cells, and a plurality of secret key numbers in a corresponding manner for each of the registered users of the apparatus 100. As shown in FIG. 17, the valid cell, which indicates the position where the converted protected information is arranged, may be expressed as a number, as long as the number corresponds to a specific position. For example, if the arrangement pattern is “Square Grid Pattern”, each cell may be expressed by any number starting from 1 to 9 using a position table illustrated in FIG. 18.

Referring back to FIG. 16, the Step S303 allows the user to select a user ID. In this example, the display processor 109 displays a message as shown in FIG. 19 on the display 30, which requests the user to select a user ID from the user IDs stored in the user preference table. By using the input device, such as the pointing device 11, the user may select one of the user IDs. The input processor 101 sends the selected user ID to the protected information converter 104 and to the verification image generator 105.

Step S304 includes converting the selected information to protected information. In this example, the protected information converter 104 obtains a secret key number from the user preference table for the selected user ID. Using the secret key number, the protected information converter 104 converts the selected information to the converted protected information in a substantially similar manner to that described with reference to the Step S104 of FIG. 3. For example, referring to FIG. 17, if the selected user ID is “0001”, the protected information converter 104 uses the secret key number “8” to generate the converted protected information.

Step S305 includes selecting an arrangement rule. In this example, the display processor 109 may display the menu shown in FIG. 6 on the display 30 which requests the user to select an arrangement rule, such as an arrangement pattern or a valid cell, for example. However, in this example, the valid cell is previously set according to the user ID. For this reason, the “Select Valid Cell” button may not be displayed to the user.

Step S306 includes generating a visible verification image having the converted protected information and the dummy information, each being arranged in the position determined by the arrangement rule set in the Step S305. In this example, the verification image generator 105 obtains the valid cell, which corresponds to the user ID, from the user preference table. For example, referring to FIG. 17, if the user ID “0001” and the “Square Grid Pattern” are selected, the verification image generator 105 obtains the valid cell “3” from the user preference table. Since the valid cell “3” corresponds to the upper right cell of the grid pattern as shown in FIG. 18, the verification image generator 105 arranges the converted protected information in the upper right cell. The dummy information is then placed in the cells other than the upper right cell.

In this manner, by storing the preference data, the operation of generating a protected document image may be simplified. Further, any user may be able to generate a protected document image for another user, as long as the user ID of the other user is known.

The operation shown in FIG. 16 may be performed in various other ways. For example, the user preference table may additionally store a symbol type or a symbol attribute for each of the registered users. In the Step S306, the verification image generator 105 may obtain the symbol type or the symbol attribute for the selected user ID, and use the obtained symbol type or the symbol attribute to generate a visible verification image.

Numerous additional modifications and variations are possible in light of the above teachings. It is therefore to be understood that within the scope of the appended claims, the disclosure of this patent specification may be practiced in ways other than those specifically described herein.

For example, the protected document image shown in FIG. 21 has a visible verification image, which is added to the lower margin of the document image. Further, the protected information, i.e., the number “3”, is indicated by the gray area. Furthermore, the visible verification image has only converted protected information, which is equal to the protected information and is expressed as a pattern.

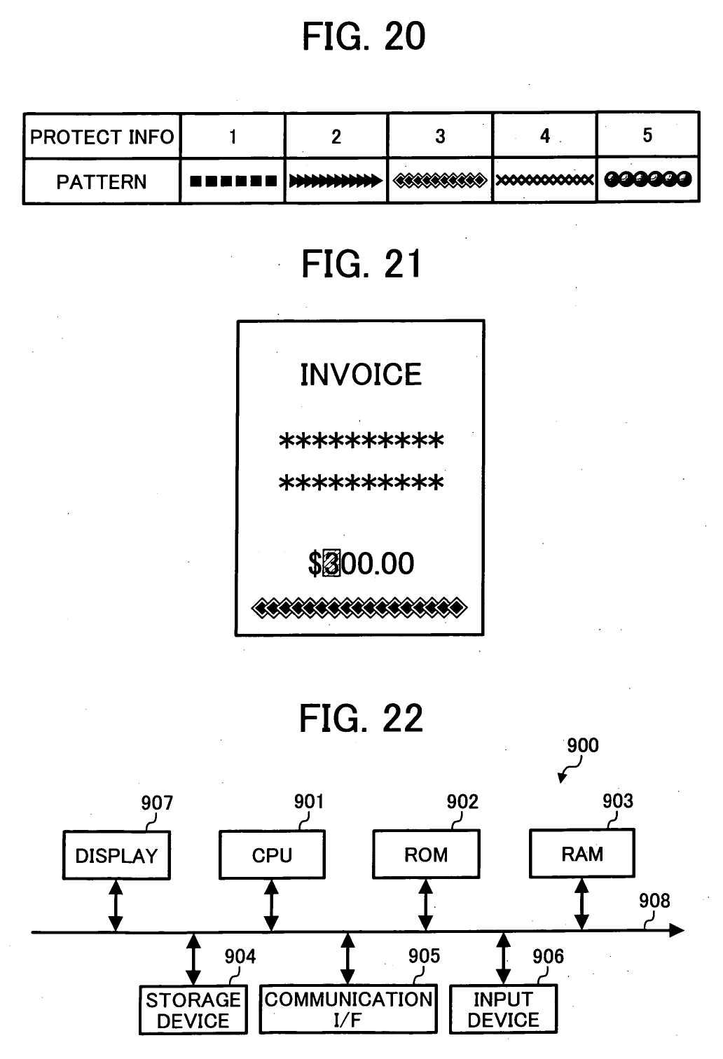

To determine whether the protected document image of FIG. 21 has been altered, the user only needs to check whether the protected information “3” matches the pattern displayed on the lower margin of the image. As long as the user recalls the correspondence between the protected information and the pattern, the user may visually check the integrity of the protected document image. Alternatively, the user may be provided with information indicating the correspondence between the protected information and the pattern, such as a pattern table shown in FIG. 20, to detect whether the protected document image has been altered.

Thus, the conversion rule, such as the secret information, may not be known to the user to generate or detect a protected document image. Further, the arrangement rule, such as the valid cell, may not be known to the user to generate or detect a protected document image.

Further, elements and/or features of the different illustrative embodiments may be combined with each other and/or substituted for each other within the scope of this disclosure and appended claims.

Furthermore, any one of the above-described methods of the present invention may be embodied in the form of a computer program stored in any kind of suitable storage device or medium. The computer program, i.e., the protected document generating program, may be incorporated into any kind of document system to create a protected document generating system. The protected document generating system may be implemented in various ways, such as with a personal computer (PC) 900 shown in FIG. 22, a multifunctional apparatus (MFP), or an image processing apparatus.

As shown in FIG. 22, the PC 900 includes a central processing unit (CPU) 901, a read only memory (ROM) 902, a random access memory (RAM) 903, a storage device 904, a communication interface (I/F) 905, an input device 906, and a display 907, which are connected to one another via a bus 908.

The CPU 901 includes any kind of processor capable of controlling operation of the system 900. The ROM 902 includes any kind of involatile memory. The RAM 903 includes any kind of volatile memory. The storage device 904 includes any kind of device capable of storing data, such as a hard disk drive (HDD), for example. The display 907 includes any kind of device capable of displaying, such as a liquid crystal display (LCD), for example. The input device 906 includes any kind of device configured to allow a user to input data, such as a keyboard or a mouse. The communication I/F 905 allows the system 900 to communicate with other apparatuses via a communication line or a network.

In one example, the protected document generating program may be installed onto the storage device 904 from a storage medium storing the protected document generating program. For this purpose, the storage device 904 may include a storage medium drive, such as-an optical disc drive, which reads the program from the storage medium. Examples of storage mediums include, but are not limited to, optical discs such as CD-ROM, CD-R, CD-RW, DVD-ROM, DVD-RAM, DVD-R, DVD+R, DVD-RW and DVD+RW, magneto optical discs, memory cards, and flexible disks. The protected document generating program may be further loaded onto the ROM 902 upon activation of the CPU 901.

In another example, the protected document generating program may be downloaded from any device or apparatus via the network, such as the Internet, through the communication I/F. Further, the protected document generating program may be uploaded to any device or apparatus via the network.

In this example, the protected document generating program includes a plurality of modules, each corresponding to the component of the protected document generating apparatus 100 shown in FIG. 2. In operation, each module is loaded onto the ROM 902 to cause the system 900 to function as the protected document generating apparatus 100.

Alternatively, any one of the above-described methods of the present invention may be implemented by ASIC, prepared by interconnecting an appropriate network of conventional component circuits or by a combination thereof with one or more conventional general purpose microprocessors and/or signal processors programmed accordingly.

1. A method for generating a protected document image, comprising the steps of:
obtaining a document image to be processed;
designating information in the document image to be protected;
converting the designated information to protected information using a conversion rule;
generating a visible verification image including the converted protected information, the converted protected information being expressed in a visible form and arranged in a position determined by an arrangement rule; and
adding the visible verification image to the document image to generate the protected document image.

2. The method of claim 1, wherein the generating step comprises the step of:
generating dummy information, the dummy information providing information different from information of the converted protected information.

3. The method of claim 2, wherein the visible verification image further includes the dummy information.

4. The method of claim 3, further comprising the step of:
expressing the dummy information in a visible form.

5. The method of claim 4, further comprising the step of:
arranging the dummy information in a position determined by the arrangement rule.

6. The method of claim 1, further comprising the step of:
adding the visible verification image to the document image as a background image.

7. The method of claim 1, further comprising the step of:
adding the visible verification to a non-data section of the document image.

8. The method of claim 1, further comprising the step of:
displaying the protected document image.

9. The method of claim 1, further comprising the step of:
storing the protected document image.

10. The method of claim 9, further comprising the step of:
printing the protected document image.

11. The method of claim 8, further comprising the step of:
confirming whether the protected document image is acceptable to generate a confirmation result.

12. The method of claim 11, further comprising the steps of:
changing the visible form to a new visible form based on the confirmation result;
generating a new verification image including the converted protected information, the converted protected information being expressed in the new visible form and arranged in the position determined by the arrangement rule; and
adding the new visible verification image to the document image to generate a new protected document image.

13. The method of claim 11, further comprising the steps of:
changing the arrangement rule to a new arrangement rule based on the confirmation result;
generating a new verification image including the converted protected information, the converted protected information being expressed in the visible form and arranged in a position determined by the new arrangement rule; and
adding the new visible verification image to the document image to generate a new protected document image.

14. The method of claim 1, further comprising the step of:
authenticating a user to generate an authentication result;
wherein the steps of obtaining, designating, converting, generating, and adding are performed based on the authentication result.

15. An image processing system, comprising:
means for obtaining a document image to be processed;
means for designating information in the document image to be protected;
means for converting the designated information to protected information using a conversion rule;
means for generating a visible verification image including the converted protected information, the converted protected information being expressed in a visible form and arranged in a position determined by an arrangement rule; and
means for adding the visible verification image to the document image to generate the protected document image.

16. The system of claim 15, further comprising:
means for receiving input information from a user;
wherein the input information includes user authentication information.

17. The system of claim 16, further comprising:
means for storing authentication information; and
means for authenticating the user using the authentication information and the user authentication information.

18. The system of claim 17, further comprising:
means for storing preference data indicating preferences of the user regarding any one of the conversion rule, the visible form, and the arrangement rule.

19. The system of claim 16, wherein the input information further comprises at least one of the conversion rule, the visible form, and the arrangement rule.

20. The system of claim 19, further comprising:
means for displaying the protected document image.

21. A computer readable medium storing computer instructions for performing an image processing operation comprising the steps of:
obtaining a document image to be processed;
designating information in the document image to be protected;
converting the designated information to protected information using a conversion rule;
generating a visible verification image including the converted protected information, the converted protected information being expressed in a visible form and arranged in a position determined by an arrangement rule; and
adding the visible verification image to the document image to generate the protected document image.

22. A computer program, configured to cause the computer to carry out the method of claim 1 when executed on a computer.
